(19) United States
(12) Patent Application Publication
(10) Pub. No.: US 2018/0089720 A1
(43) Pub. Date: Mar. 29, 2018

(54) METHOD AND SYSTEM FOR COMMUNICATING ADVERTISEMENT MATERIALS

(71) Applicant: MASTERCARD INTERNATIONAL INCORPORATED, Purchase, NY (US)

(72) Inventor: Rakesh Tiwari, Delhi (IN)

(21) Appl. No.: 15/711,090

(22) Filed: Sep. 21, 2017

(30) Foreign Application Priority Data
Sep. 27, 2016 (SG) 10201608061X

(51) Int. Cl. G06Q 30/02

(52) U.S. Cl. CPC G06Q 30/0269; G06Q 30/0267; G06Q 30/0261; G06Q 30/0255

(57) ABSTRACT

A computer-implemented method and system are provided for communicating advertisement materials to a user. In one aspect, the method includes: receiving identifier data and location data from a mobile device of the user; retrieving a profile of the user from a user database based on the identifier data, the user profile including historical spending data of the user and/or a user categorization; determining a set of advertisement materials for communication to the user, including: searching an advertisement database of advertisement materials based on the location data and user profile, each advertisement material having a predetermined set of conditions associated therewith; and selecting the set of advertisement materials based on results of the search, wherein the location data and user profile match the predetermined set of conditions of the selected set; and communicating at least one advertisement material from the selected set to the mobile device of the user.

### TECHNICAL FIELD

The present disclosure generally relates to a method and system for communicating advertisement materials. More particularly, the present disclosure describes various embodiments of a method and system for communicating advertisement/advertising/promotion/marketing materials (e.g. vouchers, offers, discounts, etc.) to a user or to a subset of users from a larger group or set of users.

### BACKGROUND

Advertising may be defined as a form of marketing communication for promoting or selling a product and/or service. Vendors such as merchants and businesses often rely on advertising channels to attract customers to purchase their products and/or services. Vendors may also engage credit card issuers to promote discounts or rebates for spending on their credit cards, or even governments/government agencies to attract travellers or tourists to visit their countries.

The emergence of online advertising channels, e.g. social media, has led to increasing progress in the use of targeted advertising. Traditional advertisements may tend to be overly generic and may not necessarily pertain to a particular customer's interests or needs. One form of targeted advertising relies on tracking of a user's Internet or online behaviour, and uses algorithms to determine the user's interests. Specific advertisement materials may be selected and communicated to the user. Such form of targeted advertising may be more effective as the user may be more interested in the selected advertisement materials.

Popular tourist countries/cities such as Singapore, Hong Kong, and London face increasing competition from one another to attract travellers/tourists. Governments may, directly or through an agency, increase investment in tourism to boost tourism expenditures and economic growth. As such, governments are keen to explore effective advertising channels that are targeted to specific users or groups of users.

Traditional targeted advertisements rely on information based on a user's internet or online behaviour. For example, a user may be searching for information on certain products, and the user would become a target of advertisement materials from the vendors of these products. However, the user may not be interested in purchasing the products; the user may be just searching for information purely for his/her research and knowledge, without any intention of purchase. There is thus no reasonable expectation that the user would make a purchase upon seeing the targeted advertisements materials. Accordingly, one problem associated with traditional targeted advertisements is that there appears to be a gap between the interests of the user, based on his/her search for information on a product or service, and actual purchase of the product or service.

Therefore, in order to address or alleviate at least one of the aforementioned problems and/or disadvantages, there is a need to provide a method and system for communicating advertisement materials, in which there is at least one improved feature over the prior art.

### SUMMARY

According to a first aspect of the present disclosure, there is a computer-implemented method for communicating advertisement materials to a user, a system implementing the method, and a non-transitory computer-readable medium storing computer-readable instructions that, when executed, cause a processor to perform steps of the method. The method comprises: receiving identifier data and location data from a mobile device of the user; retrieving a profile of the user from a user database based on the identifier data, the user profile comprising historical spending data of the user and/or a user categorization; determining a set of advertisement materials for communication to the user, comprising: searching an advertisement database of advertisement materials based on the location data and user profile, each advertisement material having a predetermined set of conditions associated therewith; and selecting the set of advertisement materials based on results of the search, wherein the location data and user profile match the predetermined set of conditions of the selected set of advertisement materials; and communicating at least one advertisement material from the selected set of advertisement materials to the mobile device of the user.

According to a second aspect of the present disclosure, there is a computer-implemented method for communicating advertisement materials to a subset of users, a system implementing the method, and a non-transitory computer-readable medium storing computer-readable instructions that, when executed, cause a processor to perform steps of the method. The method comprises: receiving identifier data and location data from mobile devices of a set of users, wherein the subset of users is derived from the set of users; retrieving a profile of each user from a user database based on the identifier data of the respective user, each user profile comprising historical spending data and/or a user categorization of the respective user; determining the subset of users from the set of users for receiving the advertisement materials, comprising: selecting, from an advertisement database of advertisement materials wherein each advertisement material has a predetermined set of conditions associated therewith, a set of advertisement materials with the same predetermined set of conditions; searching the set of users based on the predetermined set of conditions of the selected set of advertisement materials; and selecting the subset of users based on results of the search, wherein the location data and profile of each user in the subset match the predetermined set of conditions of the selected set of advertisement materials; and communicating at least one advertisement material from the selected set of advertisement materials to the mobile devices of the subset of users.

An advantage of the system and method of the present disclosure is that the advertisement materials communicated to the users are more relevant based on information from the user profiles, particularly from the historical spending data and/or user categorization. Matches between users and the selected advertisement materials would likely yield a higher hit rate per advertisement material, i.e. the users are more likely to positively respond to the advertisement materials. The selected advertisement materials are location-based and provided to the users in real-time, e.g. when the users are near vendors of the advertisement materials. This advantageously provides the users with the relevant offers at the right time and location, and provides the vendors with the right prospects. There would thus be a greater probability of the users making purchases upon seeing such targeted advertisement materials, and especially so if the users are also in the vicinity of the vendors.

Therefore, the user profiles, particularly the historical spending data, provides prior knowledge and understanding on the users' past spending behaviour, such as the products and/or services the users have previously purchased and perhaps also the frequency of spending. Advertisement materials can be more targeted to the users and there can be increased expectation that the users would make purchases upon seeing the targeted advertisement materials. This could eventually lead to increased sales and tourism (where applicable) for vendors including governments, government agencies, businesses, and/or merchants.

A method and system for communicating advertisement materials according to the present disclosure is thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIG. 1 is an illustration of a system for implementation of a method for communicating advertisement materials, in accordance with an embodiment of the present disclosure.

FIG. 2 is a flowchart illustration of the method of FIG. 1 implemented on a host server for communicating advertisement materials to a user, in accordance with an embodiment of the present disclosure.

FIG. 3 is a flowchart illustration of the method of FIG. 1 implemented on a host server for communicating advertisement materials to a subset of users, in accordance with an embodiment of the present disclosure.

FIG. 4 is an illustration of a block diagram of the technical architecture of a mobile device, in accordance with an embodiment of the present disclosure.

FIG. 5 is an illustration of a block diagram of the technical architecture of a host server, in accordance with an embodiment of the present disclosure.

### DETAILED DESCRIPTION

In the present disclosure, depiction of a given element or consideration or use of a particular element number in a particular FIG. or a reference thereto in corresponding descriptive material can encompass the same, an equivalent, or an analogous element or element number identified in another FIG. or descriptive material associated therewith. The use of “/” in a FIG. or associated text is understood to mean “and/or” unless otherwise indicated. As used herein, each of the terms “set” and “subset” corresponds to or is defined as a non-empty finite organization of elements that mathematically exhibits a cardinality of at least one (i.e., a set or subset as defined herein can correspond to a unit, singlet, or single element set, or a multiple element set), in accordance with known mathematical definitions. The recitation of a particular numerical value or value range herein is understood to include or be a recitation of an approximate numerical value or value range.

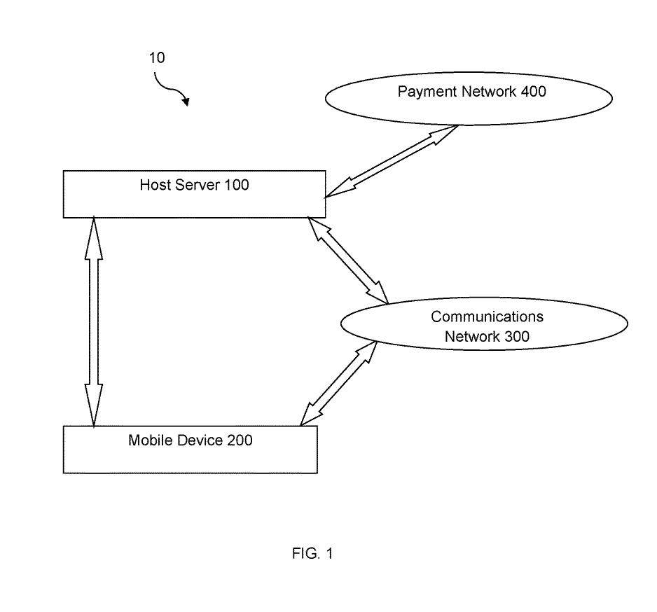

For purposes of brevity and clarity, descriptions of representative or exemplary embodiments of the present disclosure are directed to a method and system for communicating advertisement materials, in accordance with the drawings in FIG. 1 to FIG. 5. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, well-known systems, methods, procedures, and components have not been described in detail so as to not unnecessarily obscure aspects of the embodiments of the present disclosure.

In a first embodiment of the present disclosure, there is provided a system 10 for communicating or transmitting advertisement materials as illustrated in FIG. 1. The system 10 comprises a host server 100 having a processor and a memory configured to store computer-readable instructions for executing a method for communicating advertisement materials according to embodiments of the present disclosure. The system 10 further includes an electronic device of a user, e.g. a mobile device 200, wherein the mobile device 200 is communicatively linked to the host server 100. The mobile device 200 may be or include mobile phones, smartphones, personal digital assistants (PDAs), key fobs, transponder devices, NFC-enabled devices, tablets, portable display devices, and/or computers. Data may be communicated directly between the mobile device 200 and the host server 100. Alternatively, communication between the mobile device 200 and host server 100 may occur via a communications network 300, such as of a telecommunications service provider which the user is subscribed to for operation of his/her mobile device 200. The host server 100 may further be communicatively linked to a payment network 400 that links financial institutions (e.g. banks and credit card institutions) associated with payment cards (e.g. credit cards) or other payment vehicles of the user. The term “payment vehicle” may refer to any suitable cashless payment mechanism, such as a credit card, a debit card, a prepaid card, a charge card, a membership card, a promotional card, a frequent flyer card, an identification card, a gift card, and/or any other payment cards that may hold payment card information (e.g. details of user account or payment card) and which may be stored electronically on a mobile device.

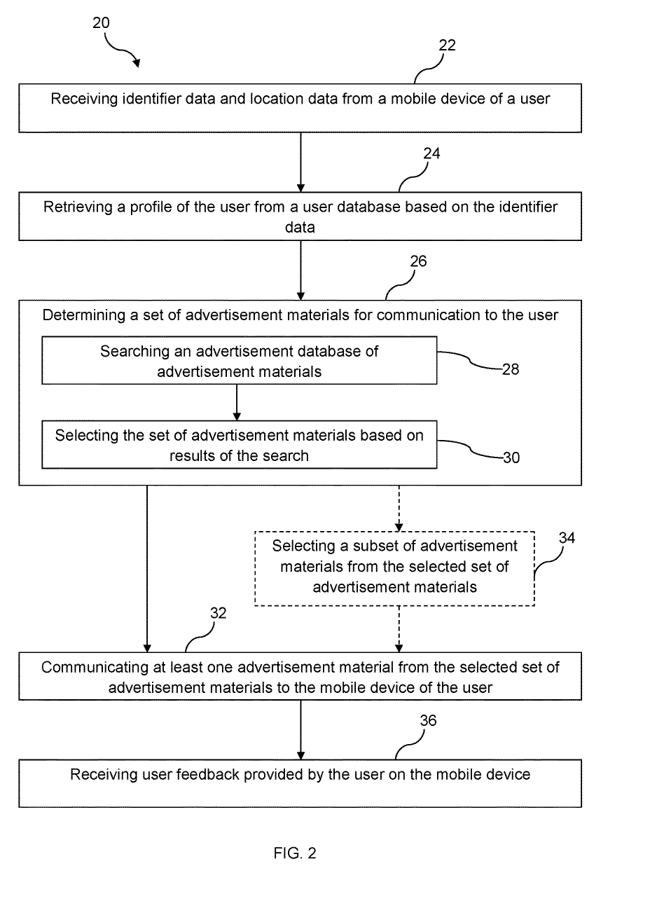

In the first embodiment with reference to FIG. 2, there is a computer-implemented method 20, i.e. implemented on a computer such as the host server 100, for communicating or transmitting advertisement materials to a user. The advertisement materials are provided by vendors and are communicated to the user via the host server 100 and/or communications network 300. The vendors may include, but are not limited to, merchants, businesses, commercial entities, service providers, governments, government agencies, tourism agencies, financial institutions, and credit card issuers. The users may include, but are not limited to, customers, consumers, leisure tourists, holidaymakers, and business travelers. In various embodiments of the present disclosure, the user is described as a tourist/traveler. It would be readily apparent and understood by the skilled person that aspects of the present disclosure may apply similarly or analogously to other types of users who may also be eligible to receive advertisement materials.

The method 20 is thus a computerized method 20 that may be performed by the host server 100 for communicating advertisement materials to the user, specifically to the mobile device 200 of the user. A software application may also be executable on the mobile device 200 to co-operate with the host server 100 for operation of the method 20, such as to receive the advertisement materials and display them on the mobile device 200 for the user to see.

If the user is a first-time user of the software application, the user may be required to download and install the software application on his/her mobile device 200. The user executes the software application and begins to create a user profile through a user registration process. The creation of the user profile requires the user to input and submit his/her user details. The user details may include, but are not limited to, the user's full name, nationality, home address, email address, and phone number—preferably the phone number associated with the mobile device 200 in order to receive advertisement materials communicated from the telecommunications service provider. During creation of the user profile, the user may be presented, on the mobile device 200, with a questionnaire or a set of questions related to his/her travel and/or spending behavior, so as to better determine the type of products and/or services that the user may be more inclined to purchase, rather than just showing an interest thereof. The set of questions may be predetermined by the vendors so that the vendors can tailor the questions to target their preferred type of customers. Alternatively, the set of questions may be randomly generated by the host server 100 from a database of predetermined questions.

Some of the questions for the user to answer may include, but are not limited to:
1. Preferred destinations of travel or for tourist visits;
2. Whether the user considers himself/herself as a business traveler or leisure traveler;
3. Type of payment cards the user prefers to use, e.g. commercial or consumer;
4. Average number of payment/spending transactions per month;
5. Average monthly spending in the payment/spending transactions;
6. Categories of products and/or services the user is interested in purchasing, e.g. food & beverage, clothing, gifts, souvenirs, departmental stores, gaming, recreation, accessories, watch, jewelry, electronic gadgets;
7. Preferred airlines for travel;
8. Preferred hotels or hotel chains for staying during travels;
9. Preferred branch locations of vendors if the vendor has multiple branches;
10. Name of vendor where user most frequently purchases from.

The user details, together with his/her answers to the questions, are communicated from the mobile device 200 to a user database to complete the user profile creation process. The user database may reside on the host server 100, or alternatively on a remote computer communicatively linked to the host server 100. A set of user login details may be generated by the host server 100 and informed to the user, e.g. communicated to his/her email address. The user may use the login details to access his/her user profile during subsequent uses of the software application. The completion of the user profile creation process correspondingly generates a profile of the user that is stored on the user database.

In addition to the user details and questionnaire answers, the user profile further includes at least one of historical spending data of the user and a user categorization. The historical spending data comprises data associated with past transactions made by the user, i.e. past spending behavior of the user (e.g. for the past 1 month, 6 months, or 1 year), and may be obtained by the host server 100 from the payment network 400. For example, the user may be holding to a number of payment cards which he/she use to make cashless payment transactions with vendors, e.g. merchants for purchasing goods. Each transaction made with any one of the payment cards may be recorded by at least one entity or financial institution (e.g. the bank issuing the payment card and the credit card institution processing the transaction) associated with the payment network 400. Such information on the past transactions made by the user may be made accessible to the host server 100 for inclusion into the user profile in the form of his/her historical spending data. Accordingly, the user's historical spending data may be derived from at least one payment vehicle or payment card of the user.

Additionally or alternatively, the user profile may comprise a user categorization or classification. Specifically, the user may be classified in one among a plurality of user categorizations or segments. In one embodiment of the present disclosure, there are four segments defined in Table 1 below.

TABLE 1

| User Categorization | Exemplary Definition/Parameters | |
|---|---|---|
| Visiting Family & | 1. | Users who did not spend at hotels at all since |
| Relatives | | the day they purchased the air tickets. |

| | |
|---|---|
| a. | No hotel transactions in destination |
| | country/city. |
| b. | No hotel/travel agency related transactions |
| | in origin country/city before their first |
| | transaction in destination country/city. |

| | | |
|---|---|---|
| | 2. | The card used is a consumer card. |
| Business Traveler | 1. | At least one transaction at hotels in destination |
| | | country/city since the day they purchased the |
| | | air tickets. |
| | 2. | At least 70% of transactions happened on |
| | | weekdays, based on number of counts. |
| | 3. | The card used is a business or commercial card. |
| Leisure Traveler | 1. | At least one transaction at hotels in destination |
| | | country/city since the day they purchased the |
| | | air tickets. |
| | 2. | At least one transaction in the leisure-related |
| | | categories of products, e.g. gaming, recreation, |
| | | watch, jewelry, apparel. |
| Miscellaneous | 1. | All other travelers that cannot be classified into |
| Traveler | | any of the above user categorizations. |

Definitions and parameters on the user categorizations or segments, as well as the number and name of each user categorization may be varied as required, according to various algorithms employed by the user database for generating the user profile. The user categorization may be derived based on the answers provided by the user in response to the questionnaire or predetermined set of questions during creation of the user profile. Further, the historical spending data of the user provided by the payment network 400 may provide additional basis for deriving the user categorization. Data analytics or analysis may be performed on the historical spending data to retrieve the relevant information for deriving the user categorization.

Based on the historical spending data of the user and/or the user categorization, the user may be further grouped into one of a plurality of audience groups, together with other users in the user database. Specifically, each user in the user database has his/her historical spending data and/or user categorization, and all the users in the user database are further grouped into audience groups. The audience groups are thus derived from the historical spending data and/or user categorization, and are defined to be more relevant to vendors, e.g. merchants. For example, some of the audience groups include, but are not limited to, (i) business travelers staying in high-end accommodation (e.g. five-star hotels); (ii) frequent travelers from China; (iii) leisure travelers with high spending in luxury apparel, and (iv) leisure travelers from India with propensity to purchase apparel at certain shopping malls. Each user may belong to one or more audience groups, and each audience group may comprise one or more users. The conditions for an audience group may be defined specifically for different vendors, depending on the vendors' requirements for their targeted groups of tourists/travelers. For example, personal details such as nationality of the user may also be retrieved from the user profile, such as if the merchant is targeting tourists from certain countries.

Table 2 below illustrates some examples of audience groups that a user may be grouped into, based on information derived from the user profile of the user. It would be readily apparent and understood by the skilled person that other variations or definitions of audience groups may be possible, and that new audience groups may also be developed.

TABLE 2

| User | | | |
|---|---|---|---|
| Catego- | | | |
| rization | Historical Spending Data | Nationality | Audience Group |
| Business | At least one past | Not | Business travelers |
| Traveler | transaction at five-star | relevant | staying in five-star |
| | hotels | | hotels |
| Leisure | At least one past | Not | Leisure travelers |
| Traveler | transaction above a | relevant | with high spending |
| | threshold amount in | | in luxury apparel |
| | leisure-related product, | | |
| | e.g. luxury apparel | | |
| Leisure | At least one past | India | Indian leisure |
| Traveler | transaction above a | | travelers with |
| | threshold amount in | | propensity to buy |
| | leisure-related product, | | apparel at said |
| | e.g. apparel at a certain | | shopping mall |
| | shopping mall | | |
| Miscella- | Multiple transactions | China | Chinese travelers |
| neous | of air tickets to a certain | | who frequently visit |
| Traveler | country/city | | said country/city |

A recommendation engine or platform residing on or communicatively linked with the host server 100 captures the information on each user in the user database, including the historical spending data, user categorization, and/or audience group. Vendors may have a preference for certain users or audience groups, and the recommendation engine would provide such audience groups to receive advertisement materials that are provided by the vendors. An advantage of this recommendation engine is that the advertisement materials communicated to the users are more relevant based on information from the historical spending data. For example, if a user has previously purchased luxury apparel products, then the advertisement materials could be related to luxury apparel products. This could increase the probability of the user taking notice of the advertisement materials and he/she may even make a purchase after seeing the advertisement materials. In addition, location data of the user may be tracked to determine whether the user is in the vicinity of a vendor, such that the advertisement materials may be transmitted to the user only when the user is near the vendor. Some vendors may also have specific requirements on the audience group of a user and the location of the user at the time of receiving the advertisement materials. An advantage is that the user can see the advertisement materials that are related to products he/she has previously purchased, and that because the user is also near the vendor or merchant of these products, he/she may be more inclined to enter the merchant's store to view the actual products. There would thus be a greater probability of the user making a purchase upon seeing such targeted advertisement materials from the recommendation engine.

According to the first embodiment of the present disclosure and as illustrated in FIG. 2, the method 20 describes a process of communicating the advertisement materials to the user. The method 20 comprises a step 22 of receiving identifier data and location data from the mobile device 200 of the user. The identifier data may be derived from the user login details when the user accesses his/her user profile when using the software application on the mobile device 200. The identifier data serves to distinguish one user from all the users within the user database. The location data serves to provide information on the current location or position of the user to the host server 100, such that the recommendation engine may be able to determine the proximity of the user to the vendors of the advertisement materials.

The location data may be provided from a geolocation module in the mobile device 200. The geolocation module is operable to determine the geolocation of the mobile device 200 (and thus the location of the user carrying the mobile device 200) using signals from, for example global positioning system (GPS) satellites. The tracking of the location of the mobile device 200 may also be performed by the subscribed telecommunications service provider, such as via a mobile communications signal between the mobile device 200 and the communications network 300.

Alternatively or additionally, the location data may be provided from a vendor based on a current transaction performed by the user at the vendor. For example, when the user makes a purchase at a vendor, e.g. merchant, with a credit card, a merchant billing machine or point-of-sale (POS) terminal processes the credit card payment through a connection to the payment network 400. The payment network 400 receives transaction data from the merchant regarding this current transaction made by the user, and this transaction data is then communicated to the host server 100. The host server 100 concurrently updates the user database based on this transaction data, i.e. updating the historical spending data of the user with the current transaction. The transaction data also contains merchant identifier data, enabling the host server 100 to identify the merchant where the user made the current transaction. The identifier data may further identify the specific branch location of the merchant, thereby determining the location of the user at the time of making the current transaction. It may be appreciated that the advertisement materials communicated to the user may be provided by this merchant, so as to recommend other products and/or services to the user and to entice the user to make additional purchases from the merchant. Alternatively or additionally, the advertisement materials communicated to the user may be provided by similar, related, or complementary merchants. Such merchants may offer similar, related, or complementary products and/or services as the merchant where the user made the current transaction.

The method 20 further comprises a step 24 of retrieving a profile of the user from the user database based on the identifier data. The user profile comprises at least one of the historical spending data, user categorization, and audience group of the user. The method 20 further comprises a step 26 of determining a set of advertisement materials for communication to the user.

The step 26 includes a step 28 of searching an advertisement database of advertisement materials. The advertisement database may reside on the host server 100, or alternatively on a remote computer communicatively linked to the host server 100. The search of the advertisement database is performed by the recommendation engine and is based on the location data and user profile of the user. Specifically, the recommendation engine analyzes the location data and other relevant data from the user profile, e.g. the historical spending data, user categorization, and/or audience group, in order to recommend the most relevant advertisement materials to the user. Each advertisement material in the advertisement database has a predetermined set of conditions or requirements associated therewith. The advertisement database contains a large number of advertisement materials and not every user would be appropriate or suitable to receive every advertisement material. Each advertisement material with the associated predetermined set of conditions is provided by a vendor for targeting users (e.g. based on audience group) who satisfy the predetermined set of conditions. Users from the same audience group would receive the same advertisement materials.

The step 26 further includes a step 30 of selecting the set of advertisement materials based on results of the search. The search attempts to match the location data and user profile of the user against the predetermined set of conditions of each advertisement material in the advertisement database. An advertisement material would be selected if the location data and user profile match the predetermined set of conditions thereof. A match between the user and an advertisement material would be advantageous as the advertisement material would be particularly relevant to the interests of the user due to past spending behavior. Further, the user would have a greater tendency to make a purchase upon seeing the advertisement material as he/she is in the vicinity of the vendor of the advertisement material. Thus, from the search of the advertisement database, advertisement materials that are matched to the user are selected into the set of advertisement materials, i.e. the location data and user profile match the predetermined set of conditions of the selected set of advertisement materials.

The method 20 further comprises a step 32 of communicating at least one advertisement material from the selected set of advertisement materials derived from the steps 26, 28, and 30. More particularly, the selected set of advertisement materials are “recommended” by the recommendation engine, and at least one advertisement material therefrom is communicated from the host server 100 to the mobile device 200 of the user. If the selected set of advertisement materials consists of only one advertisement material, then only this advertisement material would be communicated to the mobile device 200 for the user to see. However, if the selected set of advertisement materials consists of more than one or several advertisement materials, the method 20 may further include a step 34 of selecting a subset of advertisement materials from the selected set of advertisement materials. The “subset” is defined to be part of the larger “set” of advertisement materials. It would be appreciated that the subset includes the at least one advertisement material communicated to the mobile device 200 in the step 32.

The subset of advertisement materials may thus contain one or more advertisement materials for communication to the mobile device 200. The selection of the subset of advertisement materials may occur when the advertisement materials in the selected set are provided by different vendors who are targeting the same audience group at the same location (e.g. a shopping mall). It would be inconvenient for the user if the user receives all the advertisement materials in the selected set, as his/her mobile device 200 could be spammed with a series of advertisement materials, thereby negatively affecting his/her user and shopping experiences. In this regard, the recommendation engine may predefine a limit or a maximum number of advertisement materials that can be sent to a user over a predefined time period. For example, the recommendation engine may limit a maximum of 10 advertisement materials that can be sent to a user in one hour period. Alternatively or additionally, the software application on the mobile device 200 may include a function for the user to communicate a request to the host server 100, wherein the request is for limiting the number of advertisement materials received by the mobile device 200. This request may be active for a defined duration of time, such as limiting to a maximum of 10 advertisement materials in one hour. This may likewise be configured by the user in his/her user profile during the user registration process. The limit defined by the user may supersede the limit predefined by the recommendation engine.

The selection of the subset of advertisement materials in the step 34 may be based on the vendor providing the advertisement materials in the selected set and/or cost of each advertisement material in the selected set. Vendors may be required to pay to have their advertisement materials stored on the advertisement database for potential communication to users by the host server 100. Different price packages may be offered to the vendor which may affect the ranking or priority of the advertisement materials.

In one example of selecting the subset of advertisement materials, there may be two advertisement materials by two different vendors, e.g. a first advertisement material by a first vendor and a second advertisement material by a second vendor, in the selected set of advertisement materials. The first vendor may have paid for or subscribed to a higher price package than the second vendor, resulting in the cost of the first advertisement material being higher than that of the second advertisement material. As such, the first advertisement material is ranked higher than and has priority over the second advertisement material to be selected, as part of the subset in the step 34, for communication to the mobile device 200. It would be readily understood by the skilled person that the ranking process can be extended to more than two advertisement materials in the selected set, wherein advertisement materials are ranked and selected to be part of the subset. The number of advertisement materials selected into the subset may be dependent on any limit defined by the user and/or the recommendation engine.

In another example, there may be two different vendors providing two groups of advertisement materials in the selected set, e.g. a first group of advertisement materials by a first vendor and a second group of advertisement materials by a second vendor. The first vendor may have paid for or subscribed to a higher price package than the second vendor, resulting in the first vendor having priority over the second vendor. As such, advertisement materials from the first vendor, i.e. the first group of advertisement materials, would be ranked higher than and has priority over the second group of advertisement materials from the second vendor to be selected, as part of the subset in the step 34, for communication to the mobile device 200. It would be readily understood by the skilled person that the ranking process can be extended to more than two groups of advertisement materials (from more than two vendors) in the selected set. The number of advertisement materials selected into the subset may be dependent on any limit defined by the user and/or the recommendation engine.

It would be readily understood by the skilled person that the recommendation engine may employ different ranking algorithms to select the subset of advertisement materials for communication to the mobile device 200, subject to any limit on the number of advertisement materials to be received by the mobile device 200.

The advertisement materials may be communicated to the mobile device 200 directly from the host server 100 via the software application running on the mobile device 200, such as by displaying the advertisement materials on a display screen of the mobile device 200. The software application may be left to run in the background of the mobile device 200, or operating in standby mode, and the user has enabled “push notifications” such that the mobile device 200 remains connected to the host server 100 for receiving the advertisement materials. Alternatively, the advertisement materials may be communicated to the mobile device 200 by the subscribed telecommunications service provider. The communication may occur via known mobile communications signals such as Short Message Service (SMS) through the communications network 300. The host server 100 and/or telecommunications service provider thus cooperate with the vendors to send advertisement materials to the user on behalf of the vendors using the method 20. Vendors may also have advertisement campaigns in association with financial institutions, e.g. banks and credit card companies, to provide advertisement materials, e.g. discount offers, to users. The financial institutions forming part of the payment network 400 may send advertisement materials to the user on behalf of the vendors.

Subsequent to the step of communicating the at least one advertisement material to the mobile device 200, the method 20 may further comprise a step 36 of receiving user feedback provided by the user on the mobile device 200. Vendors of the advertisement materials received and seen by the user may be incentivized according to his/her user feedback.

Other than passively waiting for advertisement materials to be communicated to the mobile device 200, the user may actively utilize the software application to retrieve information on points or places or interest (POIs) in his/her vicinity. The POIs may include, but are not limited to, shopping malls, cash machines or ATMs, service amenities, and food & beverage areas. The user may request for information on POIs in his/her vicinity using the software application, wherein the information on POIs is associated with the location data from the mobile device 200. The location data determines the general location of the user and the information on POIs relates to the POIs within a predetermined radius or distance from the user's location. The information on POIs is communicated to and displayed on the mobile device 200 upon request by the user. The software application may have an embedded database of information on POIs, and/or may retrieve such information from the host server 100.

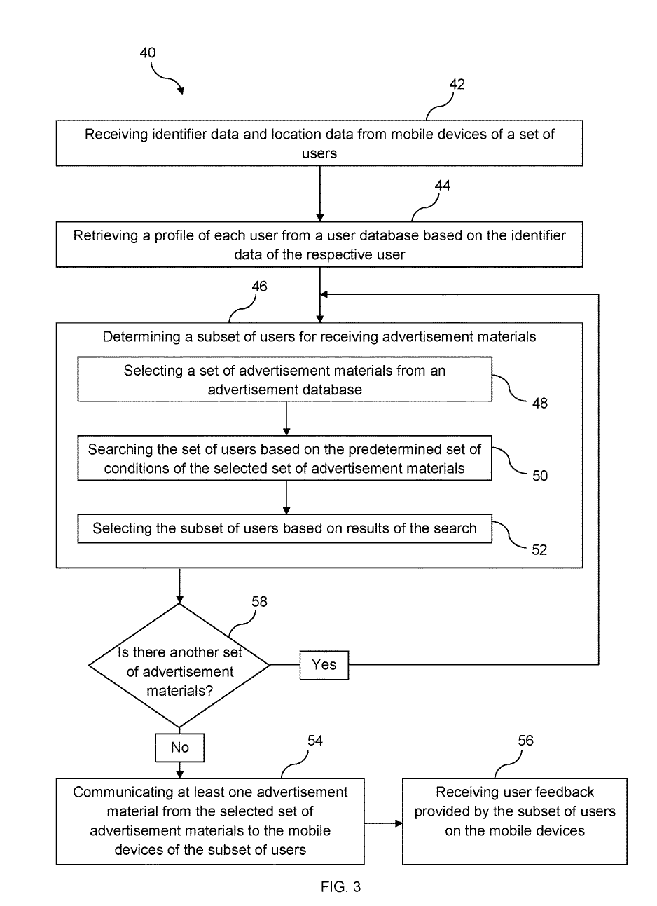

In a second embodiment of the present disclosure with reference to FIG. 3, there is a computer-implemented method 40, e.g. implemented on the host server 100, for communicating or transmitting advertisement materials to a subset of users. The “subset” of users is defined to be part of the larger “set” of users, i.e. the subset of users is derived from the set of users. It would be appreciated that the various aspects of the first embodiment in relation to the method 20 apply similarly or analogously to the second embodiment in relation to the method 40, and vice versa. For purpose of brevity, such similar or analogous aspects will not be further elaborated upon in the following description of the second embodiment.

According to the second embodiment of the present disclosure and as illustrated in FIG. 3, the method 40 is a computerized method 40 that may be performed by the host server 100 for communicating advertisement materials to the subset of users, specifically to their mobile devices 200. The method 40 comprises a step 42 of receiving identifier data and location data from the mobile devices 200 of the set of users.

For at least one user from the set of users, the location data may be provided from a geolocation module in the mobile device 200 and possibly in cooperation with the subscribed telecommunications service provider. Alternatively or additionally, the location data may be provided from a vendor(s)/merchant(s) based on current transaction(s) performed by the user(s) at the merchant(s). After the current transaction(s) are completed, the host server 100 concurrently updates the user database based on the transactions data, i.e. updating the historical spending data of the user(s) with the current transaction(s). The transactions data also contain identifier data to identify the merchant(s) where the user(s) made the current transaction(s). It may be appreciated that the advertisement materials communicated to the user(s) may be provided by the merchant(s), so as to recommend other products and/or services to the user(s) and to entice them to make additional purchases from the merchant(s). Alternatively or additionally, the advertisement materials communicated to the user(s) may be provided by similar, related, or complementary merchants. Such merchants may offer similar, related, or complementary products and/or services as the merchant(s) where the user(s) made the current transaction(s).

The method 40 further comprises a step 44 of retrieving a profile of each user (of the set of users) from the user database based on the identifier data of the respective user. The user profile comprises at least one of the historical spending data, user categorization, and audience group of the respective user. The method 40 further comprises a step 46 of determining the subset of users from the set of users for receiving the advertisement materials.

The step 46 includes a step 48 of selecting from the advertisement database of advertisement materials, wherein each advertisement material has a predetermined set of conditions associated therewith. More specifically, the step 48 selects, from the advertisement database, a set of advertisement materials with the same predetermined set of conditions, i.e. each advertisement material in the selected set has the same predetermined set of conditions.

The step 46 further includes a step 50 of searching the set of users based on the predetermined set of conditions of the selected set of advertisement materials. The search among the set of users is performed by the recommendation engine and is based on the location data and user profile of each user (within the set of users). Specifically, the recommendation engine analyzes the location data and other relevant data from the user profiles, e.g. the historical spending data, user categorization, and/or audience group, in order to recommend the appropriate or suitable user(s) (e.g. based on audience group) for receiving the selected set of advertisement materials. Each advertisement material with the associated predetermined set of conditions is provided by a vendor for targeting users (e.g. based on audience group) who satisfy the predetermined set of conditions. The selected set of advertisement materials has the same predetermined set of conditions or requirements that determine the audience group which the vendor(s) of the advertisement materials are targeting.

The step 46 further includes a step 52 of selecting the subset of users based on results of the search. The search attempts to match the location data and user profile of each user (within the set of users) against the predetermined set of conditions of each advertisement material in the selected set of advertisement materials. A user would be selected if the location data and user profile match the predetermined set of conditions of the selected set of advertisement materials. Thus, from the search among the set of users, users that are matched to the selected set of advertisement materials are selected into the subset of users. Accordingly, the location data and profile of each user in the subset of users match the predetermined set of conditions of the selected set of advertisement materials.

The method 40 further comprises a step 54 of communicating at least one advertisement material from the selected set of advertisement materials to the mobile devices of the subset of users derived from the steps 46, 48, 50, and 52. More particularly, the selected subset of users are “recommended” by the recommendation engine to receive the selected set of advertisement materials, and at least one advertisement material therefrom is communicated from the host server 100 to the mobile devices 200 of the subset of users.

If the selected set of advertisement materials has less than the total number of advertisement materials in the advertisement database, additional selection/ranking criteria/algorithms may be employed to select the set of advertisement materials from the advertisement database. The selection in the step 48 may be based on the vendor and/or cost of each advertisement material in the advertisement database. Finer selection of advertisement materials, e.g. to form a smaller subset of advertisement materials, may be performed as required, such as if the number of advertisement materials in the selected set exceed any maximum limit imposed by the user and/or recommendation engine. It would be readily understood by the skilled person that the recommendation engine may employ various ranking algorithms to select the set (or subset) of advertisement materials from the advertisement database, as described above in relation to the first embodiment.

The method 40 may further comprise a step 56 of receiving user feedback provided by the subset of users on the mobile devices 200 subsequent to communicating the at least one advertisement material to the mobile devices 200. The software application on the mobile devices 200 may include an automated function for providing feedback after the users see the advertisement material(s). The feedback may comprise various forms of data or information that the vendors are interested to know, such as but not limited to, rating of the advertisement material(s), attractiveness of promotions, and whether user would like to receive similar advertisement materials in future, etc. In addition, the vendors providing the advertisement material(s) received and seen by the users may be incentivized according to the user feedback. One example of the incentives would be the vendor earning a nominal sum of money for each advertisement material with positive user feedback. The nominal sum of money may be variable depending on the rating of the advertisement material, such as on a rating scale.

It would be appreciated that the advertisement database may comprise multiple sets of advertisement materials, each set comprising a number of advertisement materials. For every two sets, the advertisement materials therein may overlap with each other, or may be distinct from each other. Accordingly, the method 40 may include a step 58 of checking whether there is another set of advertisement materials with their same set of predetermined conditions. For example, if the advertisement database comprises a first set of advertisement materials and a second set of advertisement materials, after selection of the subset of users for the first set of advertisement materials, the step 58 checks that there is still the second set of advertisement materials. The step 58 then proceeds to repeat the step 46 of determining the subset of users for the second set of advertisement materials. Accordingly, the step 46 is repeatable for multiple sets of advertisement materials, wherein iterations of the step 46 would determine a subset of users for each set of advertisement materials.

In various embodiments of the present disclosure, the host server 100 may rely on various instruments for tracking and measuring the effectiveness of the advertisement materials, such as through the user feedback. Vendors making use of the host server 100 to communicate advertisement materials to users may request data analytics from the host server 100 to assess their advertisement campaigns.

The following is a general description of the technical architectures of the mobile device 200 and the host server 100, according to embodiments of the present disclosure.

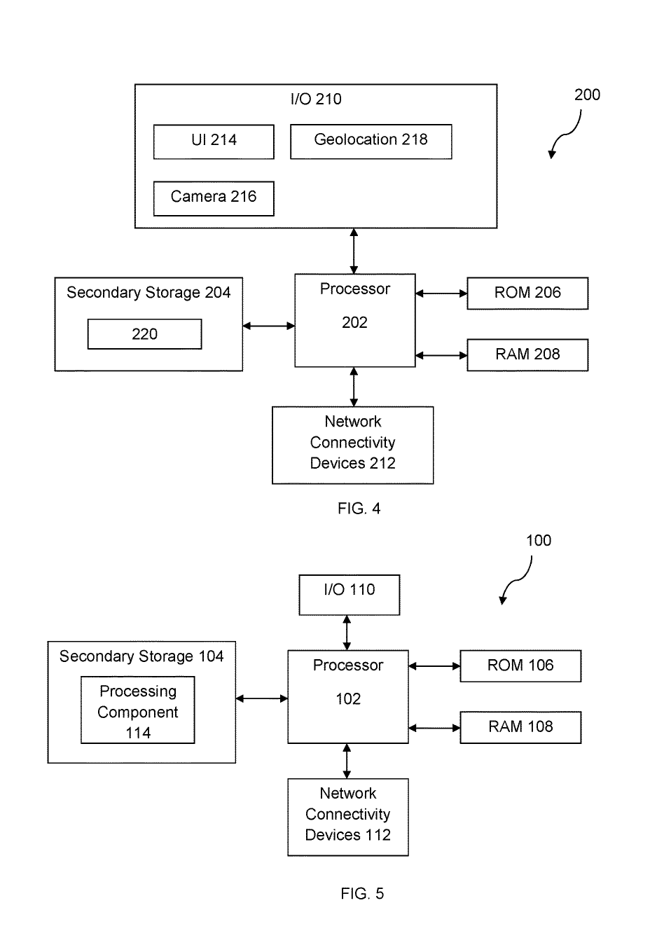

FIG. 4 illustrates a block diagram showing a technical architecture of the mobile device 200. The technical architecture includes a processor 202 (which may be referred to as a central processor unit or CPU) that is in communication with memory devices including secondary storage 204 (such as disk drives or memory cards), read only memory (ROM) 206, and random access memory (RAM) 208. The processor 202 may be implemented as one or more CPU chips. The technical architecture further comprises input/output (I/O) devices 210, and network connectivity devices 212.

The I/O devices 210 comprise a user interface (UI) 214 and a camera 216. The mobile device 200 may further include a geolocation module 218. The UI 214 may comprise a touch screen, keyboard, keypad or other known input devices. The geolocation module 218 is operable to determine the geolocation of the mobile device 200 using signals from, for example global positioning system (GPS) satellites.

The secondary storage 204 is typically comprised of a memory card or other storage device and is used for non-volatile storage of data and as an over-flow data storage device if RAM 208 is not large enough to hold all working data. Secondary storage 204 may be used to store programs which are loaded into RAM 208 when such programs are selected for execution.

The secondary storage 204 has a processing component 220, comprising non-transitory instructions operative by the processor 202 to perform various operations of the method 20/40 according to various embodiments of the present disclosure. The ROM 206 is used to store instructions and perhaps data which are read during program execution. The secondary storage 204, the ROM 206, and/or the RAM 208 may be referred to in some contexts as computer-readable storage media and/or non-transitory computer-readable media. Non-transitory computer-readable media include all computer-readable media, with the sole exception being a transitory propagating signal per se.

The network connectivity devices 212 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 212 may enable the processor 202 to communicate with the Internet or one or more intranets. With such a network connection, it is contemplated that the processor 202 might receive information from the network, or might output information to the network in the course of performing the operations or steps of the method 20/40. Such information, which is often represented as a sequence of instructions to be executed using processor 202, may be received from and outputted to the network, for example, in the form of a computer data signal embodied in a carrier wave.

The processor 202 executes instructions, codes, computer programs, scripts which it accesses from hard disk, floppy disk, optical disk (these various disk based systems may all be considered secondary storage 204), flash drive, ROM 206, RAM 208, or the network connectivity devices 212. While only one processor 202 is shown, multiple processors may be present. Thus, while instructions may be discussed as executed by a processor 202, the instructions may be executed simultaneously, serially, or otherwise executed by one or multiple processors 202.

FIG. 5 illustrates a block diagram showing a technical architecture of the host server 100. The technical architecture of the host server 100 includes a processor 102 (which may be referred to as a central processor unit or CPU) that is in communication with memory devices including secondary storage 104 (such as disk drives or memory cards), read only memory (ROM) 106, and random access memory (RAM) 108. The processor 102 may be implemented as one or more CPU chips. The technical architecture further comprises input/output (I/O) devices 110, and network connectivity devices 112.

The secondary storage 104 is typically comprised of a memory card or other storage device and is used for non-volatile storage of data and as an over-flow data storage device if RAM 108 is not large enough to hold all working data. Secondary storage 104 may be used to store programs which are loaded into RAM 108 when such programs are selected for execution.

The secondary storage 104 has a processing component 114, comprising non-transitory instructions operative by the processor 102 to perform various operations of the method 20/40 according to various embodiments of the present disclosure. The ROM 106 is used to store instructions and perhaps data which are read during program execution. The secondary storage 104, the ROM 106, and/or the RAM 108 may be referred to in some contexts as computer-readable storage media and/or non-transitory computer-readable media. Non-transitory computer-readable media include all computer-readable media, with the sole exception being a transitory propagating signal per se.

The I/O devices 110 may include printers, video monitors, liquid crystal displays (LCDs), plasma displays, touch screen displays, keyboards, keypads, switches, dials, mice, track balls, voice recognizers, card readers, paper tape readers, and/or other well-known input devices.

The network connectivity devices 112 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 112 may enable the processor 102 to communicate with the Internet or one or more intranets. With such a network connection, it is contemplated that the processor 102 might receive information from the network, or might output information to the network in the course of performing the operations or steps of the method 20/40. Such information, which is often represented as a sequence of instructions to be executed using processor 102, may be received from and outputted to the network, for example, in the form of a computer data signal embodied in a carrier wave.

The processor 102 executes instructions, codes, computer programs, scripts which it accesses from hard disk, floppy disk, optical disk (these various disk based systems may all be considered secondary storage 104), flash drive, ROM 106, RAM 108, or the network connectivity devices 112. While only one processor 102 is shown, multiple processors may be present. Thus, while instructions may be discussed as executed by a processor, the instructions may be executed simultaneously, serially, or otherwise executed by one or multiple processors.

It should be appreciated that the technical architecture of the host server 100 may be formed by one computer, or multiple computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the multiple computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture of the host server 100 and/or mobile device 200, at least one of the CPU 102/202, the ROM 106/206, and the RAM 108/208 are changed, transforming the technical architecture in part into a specific purpose machine or apparatus having the functionality as taught by various embodiments of the present disclosure. It is fundamental to the electrical engineering and software engineering arts that functionality that can be implemented by loading executable software into a computer can be converted to a hardware implementation by well-known design rules.

In the foregoing detailed description, embodiments of the present disclosure in relation to a method and system for communicating advertisement materials according are described with reference to the provided figures. The description of the various embodiments herein is not intended to call out or be limited only to specific or particular representations of the present disclosure, but merely to illustrate non-limiting examples of the present disclosure. The present disclosure serves to address at least some of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. A computer-implemented method for communicating advertisement materials to a user, the method comprising:
receiving identifier data and location data from a mobile device of the user;
retrieving a profile of the user from a user database based on the identifier data, the user profile comprising historical spending data of the user and/or a user categorization;
determining a set of advertisement materials for communication to the user, comprising:
searching an advertisement database of advertisement materials based on the location data and user profile, each advertisement material having a predetermined set of conditions associated therewith; and
selecting the set of advertisement materials based on results of the search, wherein the location data and user profile match the predetermined set of conditions of the selected set of advertisement materials;
and
communicating at least one advertisement material from the selected set of advertisement materials to the mobile device of the user.

2. The method according to claim 1, further comprising selecting a subset from the selected set of advertisement materials, the subset including the at least one advertisement material communicated to the mobile device.

3. The method according to claim 2, wherein selection of the subset of advertisement materials is based on vendor and/or cost of each advertisement material in the selected set of advertisement materials.

4. The method according to claim 1, wherein the location data is provided from a geolocation module in the mobile device.

5. The method according to claim 1, wherein the location data is provided from a vendor based on a current transaction performed by the user at the vendor.

6. The method according to claim 5, further comprising updating the historical spending data of the user with the current transaction.

7. The method according to claim 1, further comprising communicating information on points of interest (POIs) to the mobile device upon request by the user.

8. The method according to claim 7, wherein the information on POIs is associated with the location data.

9. The method according to claim 1, further comprising receiving a request from the mobile device for limiting the number of advertisement materials received by the mobile device.

10. The method according to claim 1, wherein the user categorization is derived based on answers provided by the user to a predetermined set of questions.

11. The method according to claim 10, wherein the user categorization is further derived based on the historical spending data of the user.

12. The method according to claim 1, wherein the historical spending data is derived from at least one payment vehicle of the user.

13. The method according to claim 1, wherein the user profile further comprises at least one audience group associated with the user derived from the historical spending data and/or user categorization.

14. The method according to claim 1, further comprising performing a user registration process for the user to create the user profile.

15.-25. (canceled)

26. A system for communicating advertisement materials to a user, the system comprising:
a host server comprising a processor and a memory configured to store computer-readable instructions, wherein when the instructions are executed, the processor performs steps comprising:
receiving identifier data and location data from a mobile device of the user;
retrieving a profile of the user from a user database based on the identifier data, the user profile comprising historical spending data of the user and/or a user categorization;
determining a set of advertisement materials for communication to the user, comprising:
searching an advertisement database of advertisement materials based on the location data and user profile, each advertisement material having a predetermined set of conditions associated therewith; and
selecting the set of advertisement materials based on results of the search, wherein the location data and user profile match the predetermined set of conditions of the selected set of advertisement materials;
and
communicating at least one advertisement material from the selected set of advertisement materials to the mobile device of the user.

27. (canceled)
